(19) United States
(12) Patent Application Publication
(10) Pub. No.: US 2014/0257575 A1
(43) Pub. Date: Sep. 11, 2014

(54) SYSTEMS AND METHODS FOR IMPLEMENTING ENVIRONMENTAL CONDITION CONTROL, MONITORING AND ADJUSTMENT IN ENCLOSED SPACES

(71) Applicant: Energy Efficient Technologies, LLC, Severna Park, MD (US)

(72) Inventor: Randel E. ROY, Severna Park, MD (US)

(73) Assignee: Energy Efficient Technologies, LLC, Severna Park, MD (US)

(21) Appl. No.: 14/201,774

(22) Filed: Mar. 7, 2014

Related U.S. Application Data
(60) Provisional application No. 61/775,729, filed on Mar. 11, 2013.

(51) Int. Cl. G05D 23/19

(52) U.S. Cl. CPC G05D 23/19
USPC 700/276

(57) ABSTRACT

A system and method are provided for implementing business and operational intelligence for building owners or operators regarding energy use by climate control systems in the building. Integrated monitoring, analysis, adjustment and control are provided regarding (1) operation of environmental condition control systems; (2) operating efficiency factors associated with the environmental condition control systems; (3) operating efficiency factors associated with support components, including ducting, supporting the environmental condition control systems; and (4) operating efficiency factors associated with the operating envelope of the structures within which the environmental condition control systems are operated, including building envelope inefficiencies, operating inefficiencies, and airflow inefficiencies. The disclosed schemes accumulate data at various points in an HVAC system, HVAC system ductwork and throughout an environmentally-controlled portion of the building to support analysis of system and envelope inefficiencies.

This application claims priority to U.S. Provisional Patent Application No. 61/775,729 entitled “Comfort Control Monitoring and Optimization System,” to Randel E. Roy, filed on Mar. 11, 2013, the disclosure of which is hereby incorporated by reference herein in its entirety.

### BACKGROUND

1. Field of Disclosed Subject Matter

This disclosure relates to systems and methods for implementing comfort control monitoring, adjustment, analysis and optimization in enclosed spaces in which environmental characteristics and parameters are managed through the use of at least one air handling system, including a heating, ventilation and air conditioning (HVAC) system.

2. Related Art

Environmental conditions in modern commercial and residential buildings are typically controlled to support occupant comfort, or to otherwise support some specialized purpose. Such specialized purposes can include cold rooms for refrigeration of various products, hot houses for indoor crop production, vacuum systems for maintenance of clean rooms, and/or critical control of the temperatures and/or humidity to support cooling of electronics components in, for example, large data centers. Environmental condition control is undertaken with many different and varying forms of electro-mechanical air handling devices or systems. Such electro-mechanical air handling devices are known to typically reduce temperatures and humidity within the involved buildings when outside air temperatures and humidity are higher than the temperature and humidity conditions to be maintained within the buildings. Conversely, the electro-mechanical air handling devices are also known to typically increase temperatures, while controlling humidity, within the involved buildings when outside air temperatures are lower than the temperature conditions to be maintained within the buildings. Except in the case of the certain specialized environmental conditions described briefly above, occupant comfort is generally the benchmark for adjustment of the environmental conditions within a building, or in at least particular portions of the building. Depending on a size and purpose of the building overall, the environmental conditions may be adjusted to be consistent throughout the entire building, or the environmental conditions may be otherwise individually adjusted within one or more segregated portions of the building.

Those of skill in the art recognize that generally the electro-mechanical air handling devices and/or systems, particularly those directed at comfort control for occupants of the building, are commonly referred to as heating, ventilation and air-conditioning (HVAC) systems. HVAC systems are often appropriately sized, or particularized, to provide appropriate environmental condition control within a building based on a number of factors regarding the building. These factors may include determining a specific size of a space within a building, or of the building overall, to be heated/cooled, as well as assessing typical outdoor environmental conditions in a location or region in which the building is located (often accounting for reasonable excursions beyond those typical conditions as may suit the owners, operators and/or occupants of the building). Certain assumptions and presumptions regarding (1) HVAC system operations and operating efficiency and (2) environmental integrity of the building also factor into decisions regarding a correct size of an HVAC system to be used for environmental condition control in the building.

The HVAC system, as configured and installed according to the above considerations, then operates under a variety of outdoor environmental conditions to attempt to correctly maintain the desired environmental conditions within the building. Rarely, however, will a particularly-configured HVAC system, as installed in or on a building, operate at peak efficiency in relevant external environmental conditions. As such, there may typically arise a need or desire to make some mechanical change to the HVAC equipment or its controls to improve the comfort of the building and its occupants, thereby varying the operations of the HVAC systems from its original intended design further affecting the efficient operation of the system.

HVAC systems, particularly those supporting environmental control in large commercial buildings, which, in turn, support many and widely varied businesses, can be very complex in their configuration. These HVAC systems often consist of multiple modularized components, each module, in turn, comprising significant numbers of moving parts. Mechanical system components and moving parts are often subjected to wear during operation that may cause them to operate with decreasing efficiency over time as parts wear and may ultimately wear out. Separately, mechanical system components may randomly fail in operation at any time. In some HVAC systems, certain of the modules also include one or more pressurized closed-loop sub-systems that generally contain some form of working fluid or “refrigerant.” A phase of the working fluid is changed from a liquid to a gas and back to a liquid repeatedly to effect the transfer of heat from the inside of the building to the outside of the building. These coolant loops are appropriately sized according to the above, and related, factors. Pressurized sub-systems may develop leaks that can result in reduction of the heat transfer fluid within the pressurized sub-systems causing them to operate less efficiently as fluid levels are depleted to less than optimum. Over-supply, or under-supply, of working fluid, can cause the HVAC system to operate less efficiently. A loss in working fluid from those sub-systems may lead to premature failure of the system as well. Deterioration in conditions in either of these scenarios may occur without knowledge of the owners, operators or occupants of the building being serviced by the HVAC system prior to ultimate system failure. The insidious nature of undetected degradations in HVAC system performance may lead to increasing inefficiencies adversely affecting system output causing even more random adjustments to the operation of the system thereby compounding the inefficiencies.

### SUMMARY OF THE DISCLOSED EMBODIMENTS

As is clear from the above discussion, performance and efficiency of the HVAC systems controlling environmental conditions within buildings is highly dependent on those systems being properly maintained and operating in a way consistent with the manufacturers original design concept. Despite this, in many commercial and residential buildings today, it is unlikely that the owners, operators or occupants of the buildings may pay requisite attention to the performance and the efficiency of the HVAC systems. This behavior may arise from a lack of understanding regarding the overall effect that inefficiencies in the operation of the HVAC systems may have on, for example, power requirements to support environmental condition control within the building. Otherwise, the behavior may arise from an expectation that, absent some ultimate failure of the HAC system to produce any, or any correct, output, the system is operating “correctly.” It is often the case that the first indication of some “deterioration” in a condition of an installed HVAC system may be when that system fails altogether. Fortunately for most common users, modern HVAC system installations include certain safeguard features that will shut the system down in response to certain detected faults in internal operating conditions for the system. Such safeguards are generally intended to preclude catastrophic failure of the HVAC system that may otherwise require complete replacement of the system or significant modules within the system. In the operating space between 100% efficient operations of HVAC systems and catastrophic failure, many, if not most, HVAC systems operate at less than full efficiency based on improper levels of working fluids being present, and/or overall inadequate maintenance.

An improperly-maintained HVAC system can easily require 50% more energy to operate the system than would be required for the operation of a properly maintained system. Operating costs for all manner of businesses continue to increase. Principal among such operating costs are the costs associated with the myriad power requirements that are deemed necessary to support business operations. Power consumption, and the costs associated therewith, for environmental condition control may represent an inappropriately large percentage of the total energy costs of a building, particularly when adversely affected by the compounding inefficiencies in the performance of the environmental condition control systems, including the HVAC systems, described above.

Compounding difficulties arising from inefficiencies in HVAC system operation, building owners, operators and/or occupants are generally unaware of how energy is consumed, and particularly the energy directed toward controlling the environmental conditions within their buildings and operating environments. In fact, there are presently no business metrics that may point to potential difficulties based on structural (envelope) inefficiencies within the buildings. Additionally, there are presently no business metrics that, when faced with a subjectively-determined level of difficulty, may identify potential solutions to those determined difficulties that may aid in reducing overall energy consumption for the installed HVAC systems while maintaining a comfortable environmental condition in the building.

In view of the above shortfalls in currently-available assessment tools for building owners, operators and/or occupants, it may be advantageous to introduce a system or system components, or to implement a scheme, that may provide business and operational intelligence to building owners or operators regarding energy use by environmental condition or climate control systems through integrated monitoring, analysis, adjustment and/or control of: (1) operation of the environmental condition control systems; (2) operating efficiency factors associated with the environmental condition control systems; (3) operating efficiency factors associated with support components, including ducting, supporting the environmental condition control systems; and/or (4) operating efficiency factors associated with the operating envelope of the buildings within which the environmental condition control systems are operated, including envelope inefficiencies, HVAC operating inefficiencies, and airflow inefficiencies, among others.

Exemplary embodiments of the systems and methods according to this disclosure may implement a monitoring system, process, scheme or technique that accumulates data at various points in an environmental condition control system, including an HVAC system, in supporting structural components associated with the HVAC system and throughout the environmentally-controlled portion of the building to support an analysis of system and envelope inefficiencies

Exemplary embodiments may provide analytical tools that analyze the accumulated data to isolate inefficiencies in the HVAC system, to determine duct inefficiencies and/or to assess building envelope inefficiencies. In embodiments, specifically-addressable inefficiencies may be pinpointed and provided to a building owner or operator in a form that allows those individuals to address the inefficiencies with an overall objectives of (1) reducing energy consumption, (2) extending the equipment life and (3) improving occupant comfort through elimination of one or more of the identified inefficiencies.

Exemplary embodiments may reach beyond monitoring HVAC system performance to assess effects of the interplay between the HVAC system itself, the ducting that supports the HVAC system, and the building envelope. This last piece may, for example, rely on collected data to analyze a static environmental integrity of the building in changing external environmental conditions and/or a dynamic environmental integrity of the building based on the nature of the operating environment within the building and the operations carried out within that operating environment, including occupied and non-occupied environmental envelope measurements for the building.

Exemplary embodiments may implement a process, including making appropriate use of software tools, to calculate the efficiency of the HVAC system in a real-time operating environment within a building.

In embodiments, the disclosed process may compare the HVAC system efficiency, duct efficiency and building envelope efficiency to like measures assessed for other similar buildings. By combining real-time data, analytical interplay and information from multiple buildings, the disclosed systems and methods may yield a currently-unavailable business intelligence to building owners and/or operators.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and methods for providing business and operational intelligence to building owners and operators regarding energy use in environmental condition control systems, including HVAC systems, through monitoring, analyzing, adjusting and/or controlling efficiencies in the environmental condition control systems, associated ducting and building static and operating environments, will be described, in detail, with reference to the following drawings, in which:

FIG. 1 illustrates a schematic diagram of a configuration for an operating environment within which an exemplary environmental condition control, monitoring, analysis and adjustment system according to this disclosure is employed;

FIG. 2 illustrates a block diagram of an exemplary environmental condition control, monitoring, analysis and adjustment system according to this disclosure; and

FIG. 3 illustrates a flowchart of an exemplary method for implementing environmental condition control, monitoring, analysis and adjustment according to this disclosure.

### DETAILED DESCRIPTION OF THE DISCLOSED EMBODIMENTS

The systems and methods for providing business and operational intelligence to building owners and operators regarding energy use in environmental condition control systems, including HVAC systems, through monitoring, analyzing, adjusting and/or controlling efficiencies in the environmental condition control systems, associated ducting and building. Static and operating environments according to this disclosure will generally refer to this specific utility or function for those systems and methods. Exemplary embodiments will be described and depicted in this disclosure as being particularly adaptable to controlling environmental conditions in enclosed spaces to effect occupant comfort. The disclosed systems, methods, and/or schemes should, however, not be interpreted as being specifically limited to any particular configuration of an environmental condition control device or system, an electro-mechanical air handling device or system, and/or an HVAC device or system. Additionally, exemplary embodiments of the disclosed systems, methods and/or schemes should not be interpreted as being specifically directed to any particular intended use, including any particularly limited environmental condition control or occupant comfort control. For example, the disclosed systems, methods and/or schemes may be applicable to control of environmental conditions in a space that is configured as a refrigerated space, as a greenhouse-type space, as a “clean room” workspace, as a temperature/humidity controlled data center space, or any other structure, portion of a structure, or space with a structure that may have particular temperature and humidity control requirements beyond those requirements typically imposed for occupant comfort. In other words, any advantageous combination of the disclosed features and/or schemes that may be effectively employed to provide business and/or operational intelligence to owners, operators and/or occupants of a particular climate-controlled enclosed space is contemplated as being encompassed by this disclosure.

Specific reference to, for example, various configurations of environmental condition control devices or systems, electro-mechanical air handling devices or systems and/or HVAC devices or systems as those concepts and related terms are captured and used throughout this disclosure, should not be considered as limiting those concepts or terms to any particular configuration of the respective devices, overall systems or individually-described system components or elements. The subject matter of this disclosure is intended to broadly encompass systems, devices, schemes and elements that may involve environmental condition control, climate control and the like as those functions may be familiar to those of skill in the art of environmental condition or climate control.

Conventionally, operating conditions of an HVAC system associated with a particular building may only have been evaluated under one of two conditions: (1) when the HVAC system shuts down based on failure of one or more components, or based on a system-detected fault in one or more components; or (2) when a particular, all-too-infrequent, routine maintenance interval expires, e.g., once every three to six months as part of a maintenance program initiated by the building owner or operator. In such instances, a service technician may be specifically requested to evaluate the “health” of the HVAC system. This “health” monitoring or assessment may include the service technician taking measurements of the pressure of the refrigerant in the closed loop system and/or taking measurements of the temperature differential created by the HVAC system in the enclosed space or building. While the service technician may write down the results of the evaluation as, for example, test results, the test results may be used for nothing more than for the service technician to make particular adjustments or replace particular components. The test results may then be re-evaluated by the service technician to determine whether the actions that the service technician has taken have gotten the HVAC system closer to standard operating parameters. Typically, the test results are not collected or correlated, or recorded in a database for any type of historical tracking of the maintenance condition, operating state, or operating efficiency of the HVAC system. In fact, service technician on-the-spot test results are typically discarded so as to be lost the moment the service technician leaves the building having completed servicing of the HVAC system.

Even as systems and methods may have been introduced to more routinely track the maintenance condition, operating state or operating efficiency of the HVAC system, there has remained no consistent means of measuring the static and dynamic efficiency of the building envelope itself. Moreover, duct efficiency, as a separate and distinct operating effectiveness parameter, is rarely, if ever, considered as part of the evaluation of the HVAC system by the HVAC system service technician. In short, there exists no currently-implement combination of related and interactive monitoring devices coupled to analytical software that may calculate HVAC efficiency, building envelope efficiency and duct efficiency in real time, particularly in a manner that allows for an analysis of the interaction between these efficiency components to provide business and operational intelligence to building owners or operators regarding energy use by environmental condition or climate control systems within the building.

An objective, therefore, of the disclosed systems and methods is to provide this business and operational intelligence to building owners, operators or other stakeholders regarding energy use by environmental condition or climate control systems within the building. It is intended that the disclosed systems and methods may provide these individual users or user entities with better, and more consistent, knowledge regarding how well the HVAC systems in a particular building are operating, insight into energy losses attributable to inefficiencies in the duct systems, and an analytical assessment of how much energy is being lost to the building envelope. The building owners or operators may also be afforded a capacity to compare all of these measures for one building to all of these measures for other similar buildings, whether these buildings are co-owned or owned by others. With such an analytical assessment of an overall system efficiency, it is anticipated that building owners and/or operators may institute processes that will result in reduced maintenance expenses and prolonging of the life cycles of the HVAC systems overall. An advantage of the disclosed systems and methods is that the monitoring and analysis of the HVAC system operations and operational efficiencies is advantageously supplemented with coincident monitoring and analysis of other related factors that impact an overall environmental condition or climate control scheme for a particular building. Put another way, an advantage of the disclosed schemes and techniques is provided in the reliance on collected data regarding the efficiency of the ducts and the efficiency of the building envelope, collected in real time, and analyzed to the benefit of the building owner or operator as a supplement to information regarding operations, and operational efficiencies, of the HVAC system alone.

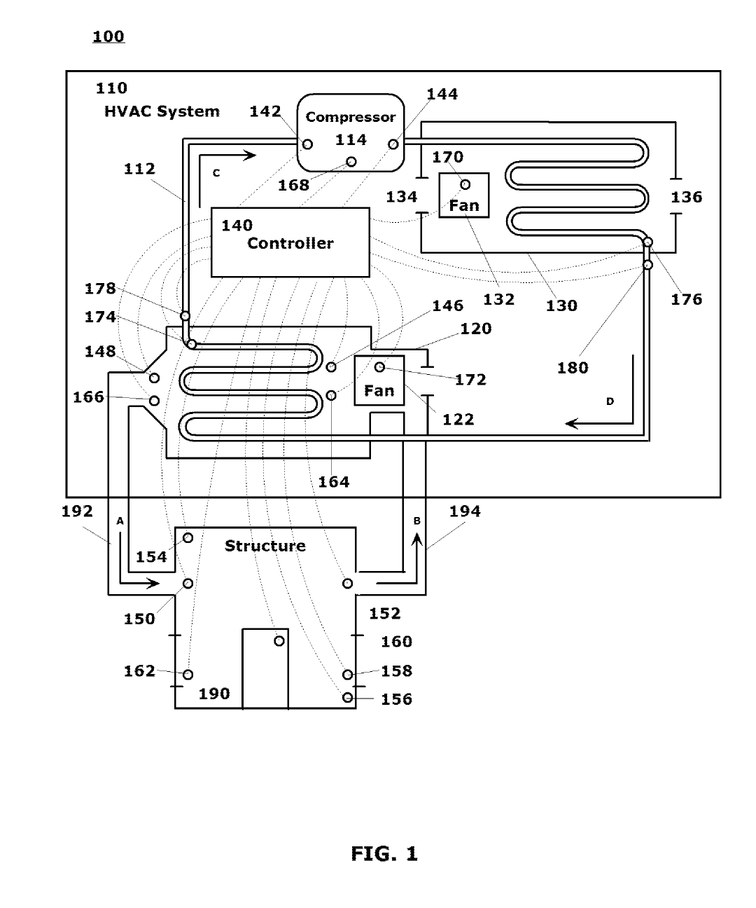

FIG. 1 illustrates a schematic diagram of a configuration for an operating environment 100 within which an exemplary environmental condition control, monitoring, analysis and adjustment system according to this disclosure is employed. As shown in FIG. 1, an exemplary structure 190 may have associated with it a particularly-configured environmental condition control or exemplary HVAC system 110. As will be described in more detail below, the particularly-configured exemplary HVAC system 110 may condition a supply of temperature-adjusted and/or humidity-adjusted forced air to be fed to the structure 190 in direction A through one or more supply ducts 192. Return air may then be recovered or evacuated from the structure 190 in direction B through one or more return ducts 194 to be re-conditioned or otherwise processed in the HVAC system 110.

Typical configurations of an exemplary HVAC system 110, such as that shown in FIG. 1, may include one or more pressurized closed-loop piping systems 112 in which a heat transfer fluid or refrigerant may be circulated in the direction indicated by arrows C and D. As is well known in the art, the heat transfer fluid is directed to an inlet side of a compressor 114. A primary function of the compressor 114 is to compress relatively cooler, low-pressure heat transfer fluid (in a vapor phase) and pump out higher-pressure hot heat transfer fluid. The compressor 114 may be a motor driven device that facilitates the flow of the heat transfer fluid through the one or more pressurized closed-loop piping systems 112 by drawing the low-pressure, low-temperature heat transfer fluid from an evaporator section 120 and outputting the high-pressure, higher temperature heat transfer fluid, compressed in the compressor 114, to a condenser section 130.

The one or more pressurized closed loop piping systems 112 may follow a serpentine path (as shown) in the condenser section 130. An object of the condenser section 130 is to function to release enough heat to the outside air to cool the heat transfer fluid from a hot gas vapor state to a less-hot liquid state. This is generally accomplished by activating a condenser fan 132 to take air from an inlet 134 opening, force that air across the one or more closed loop piping systems 112 in whatever configuration the piping may be presented in the condenser section 130, and to exhaust that air out of the condenser section 130 via, for example, an outlet 136.

The heat transfer fluid exiting the condenser section 130 in a liquid phase then continues to the evaporator section 120. The evaporator section 120 acts as a heat exchanger that exchanges heat from the return air recovered from the structure 190 via the one or more return ducts 194 with the liquid phase heat transfer fluid being carried through the evaporator section 120 by the one or more closed-loop piping systems 112, again possibly in a serpentine configuration as shown in FIG. 1. With the assistance of an evaporator fan 122 provided in the evaporator section 120, the return air from the structure 190 is forced through the evaporator section 120 across the one or more closed loop piping systems 112 circulating the heat transfer fluid. The heat transfer fluid absorbs the heat that is transferred from the air passing over the piping in the evaporator section 120. The supply air is forced back into the structure 190 via the one or more supply ducts 192 in direction A.

Those of skill in the art will recognize that the above description represents a very basic description of an operation of an exemplary HVAC system 110 such as that shown in FIG. 1, and that wide variations in included components, functions of those components, and overall system configurations may be undertaken.

The disclosed systems and methods add to the typical HVAC system 110 supporting environmental condition control in a structure 190 by providing a controller 140 in communication with a plurality of individual sensors provided in the HVAC system 110 itself, the inlet/outlet ducts 192,194 and throughout the structure 190.

The controller 140 may be particularly configured to receive signals from a plurality of temperature sensors. These temperature sensors may include, for example, a compressor inlet fluid temperature sensor 142, an evaporator outlet fluid temperature sensor 174, a condenser-outlet fluid temperature sensor 176, a compressor outlet fluid temperature sensor 144, a pre-evaporator return air temperature sensor 146, a post-evaporator supply air temperature sensor 148, a structure supply air temperature sensor 150, a structure return air temperature sensor 152, a structural environment warm air sensor 154, a structural environment cool air sensor 156, and one or more temperature sensors 158,160,162 that may be associated with one or more environmental openings from the structure to the outside environment.

The controller 140 may be further particularly configured to receive signals from a plurality of humidity sensors including, but not limited to, a pre-evaporator humidity sensor 164 and a post-evaporator humidity sensor 166.

The controller 140 may be further particularly configured to receive signals from a plurality of pressure sensors including but not limited to, a post-evaporator fluid pressure sensor 178, and a post-condenser fluid pressure sensor 180.

The compressor inlet fluid temperature sensor 142 may be placed in, or in contact with, the one or more closed loop piping systems 112 on the inlet side of the compressor 114 to take the temperature of the low pressure heat transfer fluid returning to the compressor 114. The compressor outlet fluid temperature sensor 144 may be placed in, or in contact with, the one or more closed loop piping systems 112 on the outlet side of the compressor 114 to sense the temperature of the high pressure heat transfer fluid leaving the compressor 114. The pre-evaporator return air temperature sensor 146 and the pre-evaporator humidity sensor 164 may be placed in the return airstream just prior to the evaporator, and on either side of the evaporator fan 122 in the evaporator section 120 to respectively sense the temperature and humidity of the air returning from the structure 190 via the one or more return ducts 194. The post-evaporator supply air temperature sensor 148 and the post-evaporator humidity sensor 166 may be placed in the supply air airstream just after the evaporator to sense the temperature and humidity of the air after it has been conditioned by the evaporator section 120, but prior to entering the one or more supply ducts 192 that carry the conditioned supply air to the structure 190. The structure supply air temperature sensor 150 may be placed in the supply air airstream at the mouth of the one or more supply ducts 192, for example, just at, or closely in a vicinity of, a point where the conditioned air exits the one or more supply ducts 192 to be introduced into the structure 190. This structure supply air temperature sensor 150 may measure the temperature of the conditioned supply air specifically at the point that the supply air is introduced into the structure 190. The structure return air temperature sensor 152 may be placed at the mouth of the one or more return ducts 194 at, or closely in a vicinity of, a point where the return air leaves the structure 190 on its way to be conditioned by the exemplary HVAC system 110. The structure return air temperature sensor 152 may measure the temperature of the return air at the point that the return air is being drawn into the one or more return ducts 194 exiting the structure 190.

The structural environment warm air sensor 154 may be placed in a comparatively high position within the structure 190 to assess an overall warm air temperature condition within the structure. The structural environment cool air sensor 156 may be placed in a comparatively low position within the structure 190 to assess an overall cool air temperature condition within the structure. Differences in temperatures measured by the structural environment warm air sensor 154 and the structural environment cool air sensor 156 may aid in a further detailed analysis of the environmental condition control within the structure 190. The one or more temperature sensors 158,160,162 that may be associated with one or more environmental openings from the structure 190 to the outside environment may be placed on, or in a vicinity of, respective operable doors and/or windows in the structure 190 to monitor one or more of operation of the respective operable doors and/or windows and to measure temperatures respectively in a vicinity of the operable doors and/or windows in the structure 190.

Additionally, the controller 140 may be particularly configured to receive signals from a plurality of current transducers including, but not limited to, a compressor motor current transducer 168, a condenser fan motor current transducer 170, and an evaporator/air handler fan motor current transducer 172. The compressor motor current transducer 168 may be placed on, or in a vicinity of, the electrical wiring providing electrical power to the compressor 114 to measure the electrical current flowing into the compressor 114 as a measure of the electrical power being expended by the operation of the compressor 114. The condenser fan motor current transducer 170 may be placed on, or in a vicinity of, the electrical wiring providing electrical power to a motor driving the condenser fan 132 to measure the electrical current flowing into the condenser fan 132 as a measure of the electrical power being expended by the operation of the condenser fan 132. Similarly, the evaporator/air handler fan motor current transducer 172 may be placed on, or in a vicinity of, the electrical wiring providing electrical power to a motor driving the evaporator fan 122 to measure the electrical current flowing into the evaporator fan 122 as a measure of the electrical power being expended by the operation of the evaporator fan 122.

All of the above-described temperature, humidity and/or current monitoring sensor components, as listed, may be communicatively connected to the controller 114 via one or more wired or wireless links that may allow the controller 114 to receive a signal from each of the temperature, humidity and/or current monitoring sensors, the controller 114 converting the electrical signals to temperature, humidity and/or amperage readings for each of the temperature, humidity and/or current monitoring sensors. The controller 114 may store the received sensor information in an internal data storage device and/or employ an internal processor to process the received sensor information. Otherwise, the controller 114 may transmit the received sensor information to one or more remote data storage devices to be stored and/or to one or more remote processors to be processed. Communication with any remote data storage device, or any remote processor, may be via wired or wireless means.

External data storage and/or processing capabilities may be undertaken by a dedicated local or remote computer assigned to the data monitoring, collection and analysis functions, or by a non-dedicated local or remote computer, for example, running routine that undertakes the data monitoring, collection and analysis functions along with other processing functions carried out by the non-dedicated local or remote computer.

No particular limitation on a frequency by which sensor data may be received, collected, stored and/or analyzed is implied. In other words, the sensor data may be received by the controller 140 as frequently as once every millisecond, or as infrequently as once every day. Further, it is anticipated that, in embodiments, the sensor data stored on a particular storage device may then be uploaded to a structure database to facilitate sensor data manipulation by the processor and/or to create a historical database for analysis. The disclosed local or remote processor may manipulate the collected sensor data to calculate one or more of the following measures.

An efficiency of the HVAC system itself may be calculated. An engineering-based definition of efficiency is Energy Out/Energy In, or Work Out/Work In. In one or more of the disclosed embodiments, “Energy In” may be defined as a value derived from an electricity consumption measured, for example, in watts, of the compressor motor, the condenser fan motor and the evaporator/air handling fan motor, taken in combination. The “Work Out” may be defined as a value derived from a change in temperature and humidity (enthalpy) across the one or more closed-loop piping systems 112 in the evaporator section 120 (the evaporator coil).

In addition to the overall efficiency calculations described above, there are two additional measures of efficiency that the exemplary system 100 may calculate to assess the potential source of inefficient behavior. First, the system will calculate superheat, which those of skill in the art recognize is the number of degrees a vapor is above its saturation temperature (boiling point) at a particular pressure, typically measured at the outlet of the evaporator. Second, the system will calculate sub-cooling, which those of skill in the art recognize is the number of degrees a liquid refrigerant is colder than the minimum temperature (saturation temperature) required to keep it from boiling and, hence, change from a liquid to a vapor phase, and is often calculated at the exit of the condenser.

An efficiency of the air ducting may be calculated. The air duct system supporting the structure 190, and most specifically, the one or more supply ducts 194 provide a pathway for supply air to be moved from the evaporator section 120 where the supply air is conditioned, to various parts of the structure 190 where occupants may live and/or work. Characteristics of the configuration of any air duct system, including discontinuity in construction of the individual air ducts, may create holes, gaps and other like leakage points in the air duct system. These leakage points, coupled with un-insulated exposure of the air duct system to outside air temperatures, reduce efficiency of the air duct system, i.e., ductwork is never 100% efficient.

The disclosed schemes may calculate the efficiency of the air ducting as a percentage of energy loss in the one or more supply ducts 192 relative the energy created in the evaporator section 120 as a measure of the efficiency of the one or more supply ducts 192. The efficiency of the air ducting calculations may be generally undertaken by collecting temperature data from the following sensors: the pre-evaporator return air temperature sensor 146, the post-evaporator supply air temperature sensor 148, the structure supply air temperature sensor 150 and the structure return air temperature sensor 152.

Overall duct efficiency may be broken into two distinct efficiency measurements. The first measurement is the return duct efficiency and the second is the supply duct efficiency. Combined, the return and supply duct efficiencies provide a view of the efficiency of the entire duct system. The return duct efficiency is calculated based on the temperature loss between the structure return air temperature sensor 152 and the pre-evaporator return air temperature sensor 146. Losses can be measured in degrees, or as a percentage of a total change in temperature (delta T) created by the evaporator section 120. For example, if the temperature measured by the structure return air temperature sensor 152 is 75 degrees and the temperature measured by the pre-evaporator return air temperature sensor is 78 degrees, the duct system is responsible for a loss of three degrees of cooling. Further, if the post-evaporator supply air temperature sensor 148 measures the temperature at 65 degrees, the evaporator section 120 is shown to create 10 degrees of delta T, but 3 degrees of delta T are being lost in the return duct, we would calculate that the return duct losses are equal to a value of 30%.

Supply air losses may be calculated similarly by measuring the difference between a temperature of the supply air measured by the post-evaporator supply air temperature sensor 148 and a temperature of the supply air entering the structure 190 measured by the structure supply air temperature sensor 150. If, in this example, the supply air temperature in the structure 190 as measured by the structure supply air temperature sensor 150 is 70 degrees, 5 degrees of delta T were lost in the one or more supply ducts 192. This would mean that the supply duct system, i.e., the one or more supply ducts 192, is only 50% efficient and the total duct system is only 20% efficient. Stated another way, the entire duct system has 80% losses.

While the above example is based on measuring cooling efficiency, a similar process is used in calculating duct losses when the system is operating in heating mode.

The disclosed schemes may calculate efficiency of the building envelope. Building envelope is made up of all a building's exterior structure that is exposed to outside air temperature and humidity conditions. The walls, windows, and roof make up most of the building's envelope. Conventionally, the environmental condition control industry has used R-values, or U-values to measure how well each of these exposed structural components resist heat transfer and thus assess an ability of each of these exposed structural components to keep the cold in/out and the heat out/in, depending on the external environmental conditions.

The disclosed schemes may calculate how effective the structural components of the building are combined, by calculating energy losses per square foot of exposed building envelope, measured in energy losses per square foot per hour. Because energy losses per square foot per hour vary widely based on the difference between the outside temperature and the target inside temperature, the disclosed schemes may add another dimension to the measurement in the form of degree of delta T across the building envelope. Therefore, the disclosed schemes measure building envelope efficiency in terms of, for example, a BTU loss per square foot per hour per degree of delta T.

To calculate the energy losses per square foot per hour, the disclosed schemes first calculate the actual cooling/heat delivered to the building per hour from the HVAC system. The need for heating/cooling is a function of two things, operations of the building and losses from the building envelope. The operations of the building include heat load added to the building from things like computers, heat given off by the occupants, heat generated from lighting, and heat entering the building from opening the door. These are just a few examples of the heat gained from operations (in this example, it is assumed that the building is being operated in a cooling mode, but a similar analysis can be performed when the building is being operated in a heating mode). Based on a desire to isolate and quantify a building's operational need for heating/cooling from the need for heating and cooling as a function of losses from the building envelope, the disclosed schemes first incorporate methods of isolating these two components.

One way to isolate the two components is to stop all operations of the building and measure the static heat losses/gains when the operations of the building are at a standstill. In some cases, this may be simple as understanding that many commercial building enterprises have effectively ceased all operation at night, nighttime energy requirements are then a function of building envelope static losses only. This methodology works well for restaurants, commercial office buildings and a large number of other commercial buildings that are subjected to routine periods of general inactivity.

There are, however, situations where the above measurements of static heat losses/gains may not be as easily achievable. Take, for example, operations of some commercial buildings like hospitals and hotels that are subject to virtually round-the-clock operations, at least at some level. In these cases, the disclosed schemes may measure the heat load from operations in a building by measuring the electricity consumed in the building at the main meter combined with sub-meters for major subsystem like lighting, or HVAC systems. Heat gain from operational losses is then calculated based on electricity consumption by specifically measurable types (HVAC, lighting, refrigeration, computers, etc.) times a heat loss associated with each category. The sum total of all heat lost from each category is the total operational heat gain of the building which can be subtracted from the total heat gain to get the heat gain from the building envelope.

The disclosed schemes may calculate percent energy consumed when the building is unoccupied. In this regard, the disclosed schemes are usable to calculate how much energy is consumed during occupied and non-occupied hours for a particular building. Again here, these calculations regarding the energy consumed during occupied and non-occupied hours may be made in two ways. The first way is to assume that the operational hours of the business are the occupied hours (for a restaurant and other retail establishment, the occupied hours also includes set-up and clean-up periods before and after the posted business hours open to the public). The second way is to use motion detectors to determine if anyone is still in the building. The processor may then segregate the calculations according to these categories.

Those of skill in the art will recognize that the disclosed schemes are unique in that, to date, those involved in the enclosed space environmental condition and climate control industry evaluate, if anything, only a performance, health and/or efficiency of the HVAC system, generally on an infrequent or on demand basis, e.g., either when they suspect that there is a problem, or during all-too-infrequent routine maintenance. In addition, what, if any, information that is collected is not stored for future use. The disclosed schemes address both of these shortfalls by collecting information from a plurality of sensors on a routine basis that assesses not only a performance, health and/or efficiency of the HVAC system, but also of the ducting and the building envelope as separate and distinct measure of efficiency and storing data for future use, combining it with other data and creating business intelligence that can be used to make environmental condition control decisions and/or identify environmental condition control problems in the building as a whole. Furthermore, the current procedure for collecting this information does not allow the user to calculate duct efficiency, or envelope efficiency, as this calculation requires that data be collected over time, not just at one point in time.

The disclosed schemes are unique in that a new measure of envelope efficiency is employed. In the disclosed schemes a total heat gain or loss in a building may be determined. Total building heat gain or loss has never been measured because building component manufacturers are focused on the heat gain or loss potential from a single component of the building, such as the walls, roof, windows, doors and the like, but not on the overall building as an integrated operating unit.

The disclosed systems and methods are based on an HVAC system with only one compressor, one condenser fan, and one air handling fan. The disclosed systems and methods could be similarly used on any HVAC system with multiple or single compressors, condenser fans or air handling fans. The disclosed systems and methods are based on the HVAC system being installed in a typical “Package” or “Rooftop Unit (RTU)” used in a typical commercial building application. The disclosed systems and methods may also be adapted for use in HVAC systems that are “split” or “mini-split” systems.

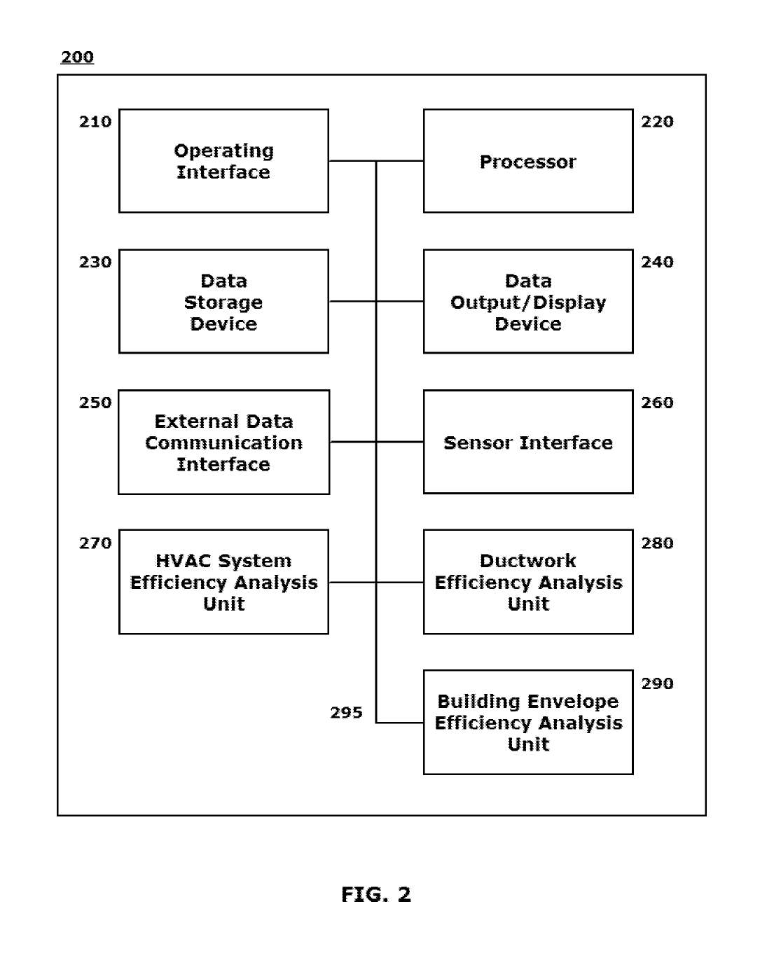

FIG. 2 illustrates a block diagram of an exemplary environmental condition control, monitoring, analysis and adjustment system 200 according to this disclosure. The exemplary system 200 shown in FIG. 2 may be implemented as a unit integral to an HVAC system, or it may be implemented as a separate unit remote from, and in communication with, the HVAC system.

The exemplary system 200 may include an operating interface 210 by which a user may communicate with the exemplary system 200 for directing at least a mode of operation of the exemplary system 200 and for directing which of a plurality of efficiencies may be calculated, stored and/or referenced by one or more of an HVAC system efficiency analysis unit 270, a ductwork efficiency analysis unit 280 and a building envelope analysis unit 290. The operating interface 210 may be a locally accessible user interface associated with the HVAC system, which may be configured as one or more conventional mechanisms common to control devices and/or computing devices that may permit a user to input information to the exemplary system 200. The operating interface 210 may be a part of a function of a graphical user interface (GUI) mounted on, integral to, or associated with, the HVAC system with which the exemplary system 200 is associated, or it may comprise any user manipulated interface associated with a local or remote computer comprising the exemplary system 200.

The exemplary system 200 may include one or more local processors 220 for individually operating the exemplary system 200. The processor 220 may reference sensor inputs received from a plurality of sensors to carry out the disclosed monitoring, adjustment, analysis, control and reporting functions. The processor 220 may reference information stored in one or more storage devices 230 for analysis of the building with which the exemplary system 200 is associated, or for taking into account stored information regarding similar buildings. Processor 220 may include at least one conventional processor or microprocessor that interprets and executes instructions to direct specific functioning of the exemplary system 200 and an associated HVAC system for controlling environmental conditions in the building with which the exemplary system 200 is associated.

The exemplary system 200 may include one or more data storage devices 230. Such data storage device(s) 230 may be used to store sensor data, calculated and/or analyzed efficiency data, and similar building data, as well as operating programs to be used by the exemplary system 200, and specifically the processor 220 in carrying into operation the disclosed functions. Data storage device(s) 230 may store an updatable database of calculations and/or analysis results.

The data storage device(s) 230 may include a random access memory (RAM) or another type of dynamic storage device that is capable of storing updatable database information, and for separately storing instructions for execution of system operations by, for example, processor 220. Data storage device(s) 230 may also include a read-only memory (ROM), which may include a conventional ROM device or another type of static storage device that stores static information and instructions for processor(s) 220. Further, the data storage device(s) 230 may be integral to the exemplary system 200, or may be provided external to, and in wired or wireless communication with, the exemplary system 200, including as cloud-based data storage devices.

The exemplary system 200 may include at least one data output/display device 240, which may be configured as one or more conventional mechanisms that output information to a user, including, but not limited to, a display screen on a GUI of an HVAC system with which the exemplary system 200 may be associated. The data output/display device 240 may be used to indicate operating conditions or modes of the HVAC system and to indicate results of calculations and/or analysis of the efficiencies discussed above.

Where appropriate, the exemplary system 200 may include at least one external data communication interface 250 by which the exemplary system 200 may communicate with the HVAC system and/or a controller associated with the HVAC system as discussed above when the exemplary system 200 constitutes one or more of the above-described remote computer, processor or data storage device.

The exemplary system 200 may include at least one sensor interface 260 by which the exemplary system 200 may be communicatively connected with a plurality of temperature, humidity and current sensors located in the HVAC system, HVAC system ductwork, and in the building serviced by the HVAC system. The communicating connections between the sensor interface and the sensors may be via wired means, wireless means, or a combination of the two.

The exemplary system 200 may include an HVAC system efficiency analysis unit 270. The HVAC system efficiency analysis unit 270 may be provided as a standalone device or as a portion, and/or as a function, of the processor 220 in communication with the at least one data storage device 230. The HVAC system efficiency analysis unit 270 may collect and process information from the one or more sensors according to the above-described calculation and analysis.

The exemplary system 200 may include a ductwork efficiency analysis unit 280. The ductwork efficiency analysis unit 280 may be provided as a standalone device or as a portion, and/or as a function, of the processor 220 in communication with the at least one data storage device 230. The ductwork efficiency analysis unit 280 may collect and process information from the one or more sensors according to the above-described calculation and analysis.

The exemplary system 200 may include a building envelope efficiency analysis unit 290. The building envelope efficiency analysis unit 290 may be provided as a standalone device or as a portion, and/or as a function, of the processor 220 in communication with the at least one data storage device 230. The building envelope efficiency analysis unit 290 may collect and process information from the one or more sensors according to the above-described calculation and analysis.

All of the various components of the exemplary system 200, as depicted in FIG. 2, may be connected internally, and potentially to a remote processing or data storage device by one or more data/control busses 295. These data/control busses 295 may provide wired or wireless communication between the various components of the exemplary system 200, whether all of those components are housed integrally in, or are otherwise external and connected to, other components of an image forming system with which the exemplary system 200 may be associated.

It should be appreciated that, although depicted in FIG. 2 as an essentially integral unit, the various disclosed elements of the exemplary system 200 may be arranged in any combination of sub-systems as individual components or combinations of components, integral to a single unit, or external to, and in wired or wireless communication with, the single unit of the exemplary system 200. In other words, no specific configuration as an integral unit or as a support unit is to be implied by the depiction in FIG. 2. Further, although depicted as individual units for ease of understanding of the details provided in this disclosure regarding the exemplary system 200, it should be understood that the described functions of any of the individually-depicted components may be undertaken, for example, by one or more processors 220 connected to, and in communication with, one or more data storage device(s) 230, all of which may support operations in the associated HVAC system.

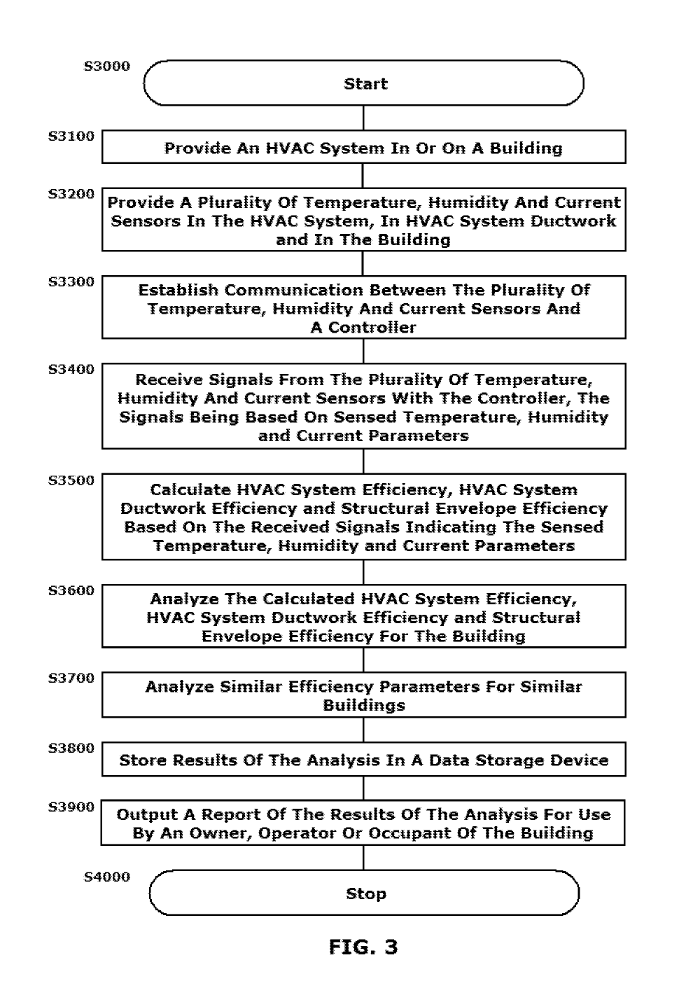

The disclosed embodiments may include an exemplary for implementing environmental condition control, monitoring, analysis and adjustment and providing business and operational intelligence to building owners and operators regarding energy use in environmental condition control systems, including HVAC systems, through monitoring, analyzing, adjusting and/or controlling efficiencies in the environmental condition control systems, associated ducting and building static and operating environments. FIG. 3 illustrates a flowchart of such an exemplary method. As shown in FIG. 3, operation of the method commences at Step S3000 and proceeds to Step S3100.

In Step S3100, an HVAC system may be provided in or on a building for adjusting environmental conditions within the building. Operation of the method proceeds to Step S3200.

In Step S3200, a plurality of temperature, humidity and/or current sensors may be provided in the provided HVAC system, in the HVAC system ductwork and in the involved building. Operation of the method proceeds to Step S3300.

In Step S3300, communication may be established between the plurality of temperature, humidity and current sensors and a controller in the building. Operation of the method proceeds to Step S3400.

In Step S3400, signals may be received with the controller from the plurality of temperature, humidity and current sensors. The signals may be based on sensed temperature, humidity and current parameters. Operation of the method proceeds to Step S3500.

In Step S3500, at least two of (1) an HVAC system efficiency, (2) a ductwork efficiency, and (3) a structural envelope efficiency, may be calculated with an integral processor in the controller, or with a local or remote processor communicating with the controller. Operation of the method proceeds to Step S3600.

In Step S3600, the at least two of the HVAC system efficiency, ductwork efficiency and structural envelope efficiency may be analyzed to determine one or more causes of calculated inefficiencies. Operation of the method proceeds to Step S3700.

In Step S3700, the analysis may be expanded to include similar efficiency parameters pertaining to similar buildings that may have been previously calculated and that may be stored, for example, in one or more databases. Operation of the method proceeds to Step S3800.

In Step S3800, results of the analysis may be stored in a data storage device associated with the controller or a local or remote processor. Operation of the method proceeds to Step S3900.

In Step S3900, a report of the results of the analysis may be output for use by an owner, an operator or an occupant of the building. The report may be displayed on a display device, may be printed on an image forming device or may otherwise be output to building owner, operator or occupant in any usable form. Operation of the method proceeds to Step S4000, where operation of the method ceases.

The above-described exemplary systems and methods reference certain conventional components to provide a brief, general description of suitable environmental condition control means for clarity and ease of understanding. Those skilled in the art will appreciate that other embodiments of the disclosed subject matter may be practiced with many types and configurations of individual devices and combinations of devices particularly common to HVAC and/or climate control systems of varying complexity. No limitation to the variety or configuration of individual component devices included in the environmental condition control systems is to be inferred from the above description.

The exemplary depicted sequences of executable instructions represent only examples of corresponding sequences of acts for implementing the functions described in the steps. The exemplary depicted steps in the above-described methods may be executed in any reasonable order to carry into effect the objectives of the disclosed embodiments. No particular order to the disclosed steps of the method is necessarily implied by the depiction in FIG. 3, and the accompanying description, except where a particular method step is a necessary precondition to execution of any other method step. Individual method steps may be carried out in sequence or in parallel in simultaneous or near simultaneous timing, as appropriate.

Although the above description may contain specific details, they should not be construed as limiting the claims in any way. Other configurations of the described embodiments of the disclosed systems and methods are part of the scope of this disclosure. For example, the above-described sensing and processing functions may be carried out by any form of sensor typically adapted for use in recovering temperature, humidity and power consumption values. The described control and processing functions may be carried out using hardware circuits, software instructions, or firmware, as well as with combinations thereof.

It will be appreciated that a variety of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A climate control monitoring system, comprising:
a first plurality of sensors positioned to sense environmental parameters of at least a first one of a climate control system, climate control ducting and a building supported by the climate control system;
a second plurality of sensors positioned to sense environmental parameters of at least a second one of the climate control system, the climate control ducting and the building supported by the climate control system;
a processor in communication with the first plurality of sensors and the second plurality of sensors, the processor being programmed to
obtain signals from the first plurality of sensors and the second plurality of sensors corresponding to the sensed environmental parameters; and
calculate an efficiency of at least two of the climate control system, the climate control ducting and an envelope of the building.

2. The climate control monitoring system of claim 1, further comprising an output device, the processor being further programmed to output a result of the calculation to a user via the output device.

3. The climate control monitoring system of claim 1, further comprising a storage device that stores a result of the calculation.

4. The climate control monitoring system of claim 1, at least one of the first plurality of sensors and the second plurality of sensors including a temperature sensor, a humidity sensor, a pressure sensor and a current sensor.

5. The climate control monitoring system of claim 1, the processor being further programmed to calculate the efficiency of the climate control system by
determining a rate of electrical consumption of the climate control system as energy into the climate control system;
determining a change in temperature between return air recovered from the structure and supply air provided to the structure after being conditioned by the climate control system as energy out of the climate control system; and
expressing the efficiency of the climate control system as a ratio of the energy into the climate control system and the energy out of the climate control system.

6. The climate control monitoring system of claim 1, the processor being further programmed to calculate the efficiency of the climate control ducting by
measuring a first temperature of air entering an upstream end in an air flow direction of at least one of a supply duct and a return duct;
measuring a second temperature of air exiting a downstream end in the air flow direction of the at least one of a supply duct and the return duct;
determining a duct change in temperature between the first temperature and the second temperature;
determining an overall change in temperature between the return air recovered from the structure and supply air provided to the structure after being conditioned by the climate control system; and
expressing the efficiency of the climate control ducting as a ratio of the duct change in temperature and the overall change in temperature.

7. The climate control monitoring system of claim 1, the processor being further programmed to calculate the efficiency of the envelope of the building by
calculating a rate of total cooling or heating delivered to the building;
calculating a heat load generated by operations within the building based on a rate of energy consumption in the building;
determining environmental losses attributable to the envelope of the building as a difference in the above calculations; and
expressing the efficiency of the envelope of the building as a ratio of the determined environmental losses to the calculated rate of total cooling or heating.

8. The climate control monitoring system of claim 7, the processor being further programmed to calculate the efficiency of the envelope of the building separately for periods when the building is occupied and when the building is unoccupied.

9. The climate control monitoring system of claim 1, further comprising a third plurality of sensors,
the first plurality of sensors being positioned to sense the environmental parameters of the climate control system,
the second plurality of sensors being positioned to sense the environmental parameters of the climate control ducting, and
the third plurality of sensors being positioned to sense the environmental parameters of the building supported by the climate control system,
the processor being further programmed to
obtain signals from the third plurality of sensors corresponding to the sensed environmental parameters; and
calculate an efficiency of the climate control system, the climate control ducting and an envelope of the building.

10. The climate control monitoring system of claim 9, the second plurality of sensors consisting of sensors that are different from the first plurality of sensors, and the third plurality of sensors consisting of sensors that are different from the first plurality of sensors and the second plurality of sensors.

11. A method for determining a climate control efficiency in a building, comprising:
positioning a first plurality of sensors to sense environmental parameters of at least a first one of a climate control system, climate control ducting and a building supported by the climate control system;
positioning a second plurality of sensors to sense environmental parameters of at least a second one of the climate control system, the climate control ducting and the building supported by the climate control system;
establishing communication between a processor and (1) the first plurality of sensors and (2) the second plurality of sensors;
obtaining, with the processor, signals from the first plurality of sensors and the second plurality of sensors corresponding to the sensed environmental parameters;
calculating, with the processor, an efficiency of at least two of the climate control system, the climate control ducting and an envelope of the building based on the obtained signals; and
outputting a result of the calculation to a user.

12. The method of claim 11, further comprising storing the result of the calculation in a data storage device.

13. The method of claim 11, at least one of the first plurality of sensors and the second plurality of sensors including a temperature sensor, a humidity sensor and a current sensor.

14. The method of claim 11, further comprising calculating the efficiency of the climate control system by
receiving, with the processor, a first signal based on electrical power directed to the climate control system;
determining, with the processor, a rate of electrical consumption of the climate control system based on the received first signal as energy into the climate control system;
receiving, with the processor, second signals based on measured temperatures of return air recovered from the building and supply air provided to the building after being conditioned by the climate control system;
determining, with the processor, a change in temperature between the return air recovered from the building and the supply air provided to the building after being conditioned by the climate control system as energy out of the climate control system; and
expressing the efficiency of the climate control system as a ratio of the energy into the climate control system and the energy out of the climate control system.

15. The method of claim 11, further comprising calculating the efficiency of the climate control ducting by
measuring, with an inlet temperature sensor, a first temperature of air entering an upstream end in an air flow direction of at least one of a supply duct and a return duct;
measuring, with an outlet temperature sensor, a second temperature of air exiting a downstream end in the air flow direction of the at least one of a supply duct and the return duct;
determining, with the processor, a duct change in temperature between the first temperature and the second temperature;
determining, with the processor, an overall change in temperature between the return air recovered from the building and supply air provided to the building after being conditioned by the climate control system; and
expressing the efficiency of the climate control ducting as a ratio of the duct change in temperature and the overall change in temperature.

16. The method of claim 11, further comprising calculating the efficiency of the envelope of the building by
calculating, with the processor, a rate of total cooling or heating delivered to the building;
calculating, with the processor, a heat load generated by operations within the building based on a rate of energy consumption in the building;
determining, with the processor, environmental losses attributable to the envelope of the building as a difference in the above calculations; and
expressing the efficiency of the envelope of the building as a ratio of the determined environmental losses to the calculated rate of total cooling or heating.

17. The method of claim 16, further comprising calculating the efficiency of the envelope of the building separately for periods when the building is occupied and when the building is unoccupied.

18. The method of claim 11, further comprising
positioning the first plurality of sensors to sense the environmental parameters of the climate control system;
positioning the second plurality of sensors to sense the environmental parameters of the climate control ducting, and
positioning a third plurality of sensors to sense the environmental parameters of the building supported by the climate control system;
obtaining, with the processor, signals from the third plurality of sensors corresponding to the sensed environmental parameters; and
calculating, with the processor, the efficiency of the climate control system, the climate control ducting and the envelope of the building.

19. The method of claim 18, further comprising:
analyzing the efficiency of the climate control system, the climate control ducting and the envelope of the building;
determining corrective measures to increase efficiency based on the analysis; and
providing to the user a report on the determined corrective measures.

20. The method of claim 18, the second plurality of sensors consisting of sensors that are different from the first plurality of sensors, and the third plurality of sensors consisting of sensors that are different from the first plurality of sensors and the second plurality of sensors.
